(19) United States
(12) Patent Application Publication
(10) Pub. No.: US 2011/0243507 A1
(43) Pub. Date: Oct. 6, 2011

(54) OPTICAL CONNECTOR AND OPTICAL APPARATUS HAVING THE SAME

(75) Inventors: Do Won KIM, Daejeon (KR); Gyungock Kim, Seoul (KR); Duk Jun Kim, Daejeon (KR)

(73) Assignee: Electronics and Telecommunications Research Institute, Daejeon (KR)

(21) Appl. No.: 12/886,848

(22) Filed: Sep. 21, 2010

(30) Foreign Application Priority Data
Apr. 5, 2010 (KR) 10-2010-0030875

(51) Int. Cl. G02B 6/36

(52) U.S. Cl. 385/78

(57) ABSTRACT

Provided are an optical connector and an optical apparatus having the same. The optical connector comprises a substrate, at least one optical waveguide, an optical coupler, and a ferrule alignment unit. The at least one optical waveguide is formed on the substrate. The optical coupler is formed on the optical waveguide. The ferrule alignment unit allows a ferrule fixing optical fibers combined with the optical coupler to be aligned with the substrate.

### CROSS-REFERENCE TO RELATED APPLICATIONS

This U.S. non-provisional patent application claims priority under 35 U.S.C. §119 of Korean Patent Application No. 10-2010-0030875, filed on Apr. 5, 2010, the entire contents of which are hereby incorporated by reference.

### BACKGROUND OF THE INVENTION

The present invention disclosed herein relates to an optical connector and an optical apparatus having the same, and more particularly, to an optical connector and an optical apparatus having the same, which align a ferrule aligning optical fibers and a substrate having optical waveguides disposed therein.

Technologies of transmitting data using light have great potential in that large-capacity data required in the IT-oriented society can be transmitted at a high rate. Along with the above advantage, long-distance optical communication technologies have been early developed and commercialized, and studies on short-distance optical interconnection are being extensively conducted in the recent years. The optical interconnection technologies are being widely applied to computers and mobile devices. The optical interconnection technologies are being developed in a direction of increasing coupling efficiency of optical connectors.

### SUMMARY OF THE INVENTION

The present invention provides an optical connector and an optical apparatus having the same, which can increase alignment efficiency.

The present invention also provides an optical connector and an optical apparatus having the same, which can increase optical coupling reliability.

Embodiments of the present invention provide optical connectors comprising: a substrate; at least one optical waveguide on the substrate; an optical coupler on the optical waveguide; and a ferrule alignment unit allowing a ferrule fixing optical fibers combined with the optical coupler to be align with the substrate.

In some embodiments, the ferrule alignment unit may comprise a plurality of pin holes in the substrate.

In other embodiments, the plurality of pin holes may be formed at both sides of the optical coupler in a direction of crossing the optical waveguide.

In still other embodiments, the plurality of pin holes may be colinear with the optical coupler.

In even other embodiments, the optical connector may further comprise guide pins inserted into the plurality of pin holes.

In yet other embodiments, the optical connector may further comprise an auxiliary substrate disposed under the substrate.

In further embodiments, the auxiliary substrate may have an auxiliary pin hole having the same size as the pin holes.

In still further embodiments, the ferrule alignment unit may comprise a plurality of studs.

In even further embodiments, the studs may comprise at least one of a thin film pattern and a solder ball.

In yet further embodiments, the ferrule alignment unit may comprise a pin hole and a stud formed at both sides of the optical waveguide in a direction of crossing the optical waveguide, respectively.

In much further embodiment, the optical coupler may comprise a grating coupler.

In other embodiments of the present invention, optical apparatuses comprise: an optical fiber; a ferrule fixing the optical fiber; and an optical connector comprising an optical coupler combined with the optical fiber fixed in the ferrule, an optical waveguide connected to the optical coupler, a substrate comprising the optical waveguide and the optical coupler formed therein, and a ferrule alignment unit aligning the ferrule on the substrate.

In some embodiments, the ferrule may have a second pin hole corresponding to the ferrule alignment unit on the substrate.

In other embodiments, the ferrule alignment unit may comprise a stud inserted into the second pin hole.

In still other embodiments, the optical apparatuses may further comprise a guide pin inserted into the second pin hole.

In even other embodiments, the ferrule alignment unit may have a first pin hole allowing the guide pin inserted into the second pin hole to pass through.

In yet other embodiments, the ferrule may allow the optical fiber to be coupled to the optical coupler at an inclined angle of about 70 degrees to about 80 degrees.

### BRIEF DESCRIPTION OF THE DRAWINGS

The accompanying drawings are comprised to provide a further understanding of the present invention, and are incorporated in and constitute a part of this specification. The drawings illustrate exemplary embodiments of the present invention and, together with the description, serve to explain principles of the present invention. In the drawings:

FIGS. 1 and 2 are exploded and assembled perspective views illustrating an optical apparatus comprising an optical connector according to a first embodiment of the present invention;

FIGS. 3 and 4 are exploded and assembled perspective views illustrating an optical apparatus comprising an optical connector according to a second embodiment of the present invention; and

FIGS. 5 and 6 are exploded and assembled perspective views illustrating an optical apparatus comprising an optical connector according to a third embodiment of the present invention.

### DETAILED DESCRIPTION OF PREFERRED EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the drawings, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

In the following description, the technical terms are used only for explain a specific exemplary embodiment while not limiting the present invention. The terms of a singular form may comprise plural forms unless referred to the contrary. The meaning of “comprise,” or “comprising,” specifies a property, a region, a fixed number, a step, a process, an element and/or a component but does not exclude other properties, regions, fixed numbers, steps, processes, elements and/or components. It will be understood that when an element such as a layer, film, region, or substrate is referred to as being “on” another element, it can be directly on the other element or intervening elements may also be present.

Hereinafter, it will be described about an exemplary embodiment of the present invention in conjunction with the accompanying drawings.

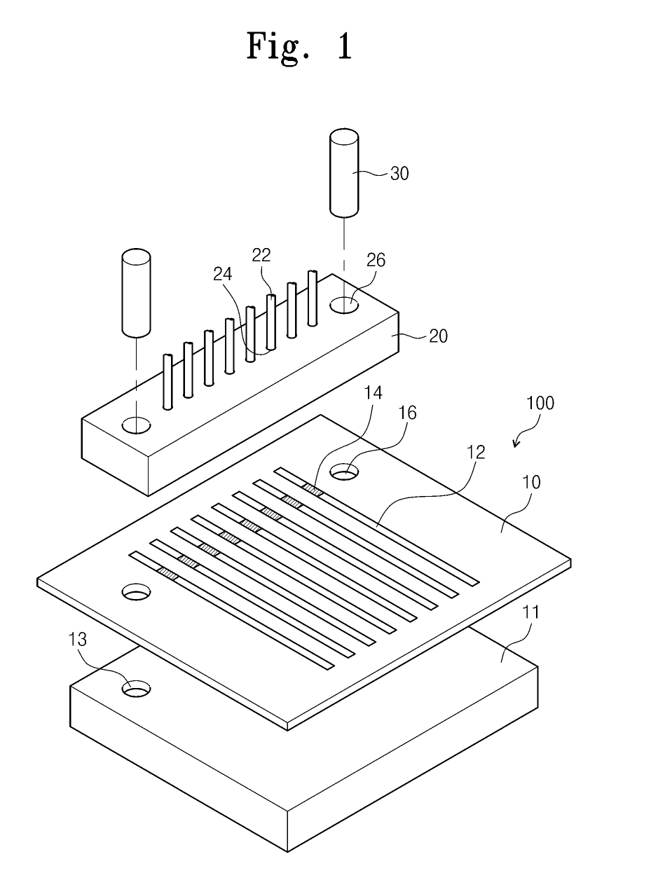

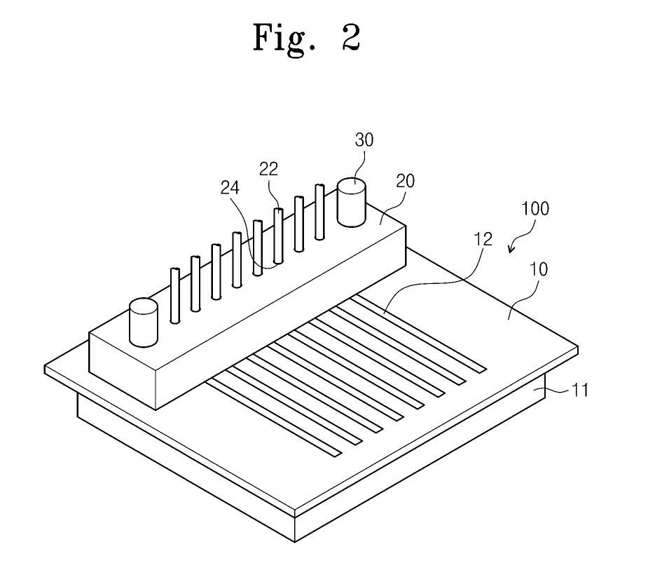

FIGS. 1 and 2 are exploded and assembled perspective views illustrating an optical apparatus comprising an optical connector according to a first embodiment of the present invention.

Referring to FIGS. 1 and 2, an optical connector 100 according to a first embodiment of the present invention may comprise a plurality of first pin holes 16 into which guide pins 30 are inserted through a substrate 10 at the both sides of optical waveguides 12 that are optically combined with optical fibers 22 arranged in a ferrule 20. The plurality of first pin holes 16 may allow the guide pins 30 to penetrate through the substrate 10. The guide pins 30 may penetrate through the plurality of first pin holes 16 formed in the substrate 10, and a plurality of second pin holes 26 formed in the ferrule 20.

The optical connector 100 according to the first embodiment of the present invention can increase arrangement efficiency using the plurality of first pin holes 16 allowing the guide pins 30 inserted into the second pin holes 26 of the ferrule 20 to pass through. Also, the optical connector 100 can increase optical coupling reliability of the optical fibers 22 arranged in the ferrule 20 and the optical waveguides 12 disposed in the substrate 10.

The optical waver guides 12 may deliver optical signals inputted or outputted through the optical fibers 22. The optical waveguides 12 may be disposed in or on the substrate 10. For example, the optical waveguides 12 may be formed of crystalline silicon or polysilicon materials. The optical waveguides 12 may be connected to photoelectric elements (not shown) disposed in the substrate 10. Although not shown, the photoelectric elements may comprise at least one of semiconductor optical amplifiers, optical modulators, multiplexers, and demultiplexers. The substrate 10 may also comprise a photoelectric element chip integrated with at least one photoelectric element.

The substrate 10 may comprise a flat plate in which the optical waveguides 12 are disposed. The substrate 10 may comprise a wafer including at least one of crystalline silicon, silicon oxide, and glass. The substrate 10 may be formed of silicon oxide and glass. Since the substrate 10 is vulnerable to external shocks, the substrate 10 may be protected by an auxiliary substrate 11. The auxiliary substrate 11 may fix the guide pin 30 inserted into the first pin holes 16. That is, the substrate 10 may be protected between the auxiliary substrate 11 and the ferrule 20. Although not shown, the auxiliary substrate 11 may comprise a plurality of auxiliary pin holes 13. The guide pin 30 may be inserted into the plurality of auxiliary pin holes 13. For example, the auxiliary substrate 11 may comprise a plastic substrate.

An optical coupler 14 may be disposed between the optical waveguides 12 and the optical fibers 22. For example, the optical coupler 14 may comprise a grating coupler. The grating coupler may comprise a plurality of line, and mesh, or concentric circle-shaped grooves formed in the optical waveguides 12 contacting the optical fibers 22.

The plurality of first pin holes 16 may be formed at the both side of the optical coupler 14 disposed in the optical waveguide 12. For example, the plurality of first pin holes 16 may be collinear with the optical coupler 14. The plurality of first pin holes 16 may be disposed vertically to the longitudinal length of the optical waveguides 12. The optical waveguides 12 and the optical coupler 14 may be disposed at the same interval between the plurality of first pin holes 16. The plurality of first pin holes 16 may correspond to the plurality of pin holes 26 through the guide pins 30. The distance between the plurality of first pin holes 16 may be the same as that between the plurality of second pin holes 26. Accordingly, the plurality of first pin holes 16 may become a ferrule guide unit that guides the ferrule 20 coupled to the substrate 10.

The optical fibers 22 may be coupled vertically or at a certain angle to the optical waveguides 12. For example, the optical fibers 22 may allow light to be incident at an incidence angle of about 1° to about 20° to the optical waveguides 12 and the optical coupler 14 to minimize the reflection loss. That is, the optical fibers 22 may be coupled to the optical coupler 14 at an inclined angle of about 70° to about 89° to the horizontal plane of the substrate 10. The plurality of optical fibers 22 may be aligned by the ferrule 20. The ferrule 20 may fix the plurality of optical fibers 22 coupled to the optical coupler 14 and the optical waveguides 12. The ferrule 20 may be disposed on the substrate 10. For example, the ferrule 20 may have a rectangular parallelepiped shape having an undersurface parallel to the substrate 10. The ferrule 20 may comprise stainless steel, polymer, or ceramic. The ceramic may comprise aluminium oxide or zirconium oxide. The ferrule 20 may comprise at least one through hole 24 through which the optical fibers 22 pass. Also, the ferrule 20 may comprise the second pin holes 26 formed to the outside of the through hole 24. The second pin holes 26 may have the same inner diameter as the first pin holes 16. The second pin holes 26 may be symmetrically formed at both side of the ferrule 20.

The guide pins 30 may pass through the second pin holes 26 of the ferrule 20 and the first pin holes 16 of the substrate 10. The guide pins 30 may fixe the ferrule 20 and the substrate 10. The guide pins 30 may align the ferrule 20 and the substrate 10. For example, when the external diameter of the guide pin 30 is the same as the inner diameters of the first pin holes 16 and the second pin holes 26, the guide pin 30 may fix the ferrule 20 and the substrate 10. Also, when adhesive is coated on the first pin holes 16 and the second pin holes 26 into which the guide pin 30 is inserted, the ferrule 20 and the substrate 10 may be fixed. The guide pin 30 may be formed with a shaft or wedge shape.

Accordingly, the optical connector 100 according to the first embodiment of the present invention may increase optical alignment efficiency of the substrate 10 and the ferrule 20 using the plurality of first pin holes 16 into which the guide pins 30 are inserted in the substrate 10.

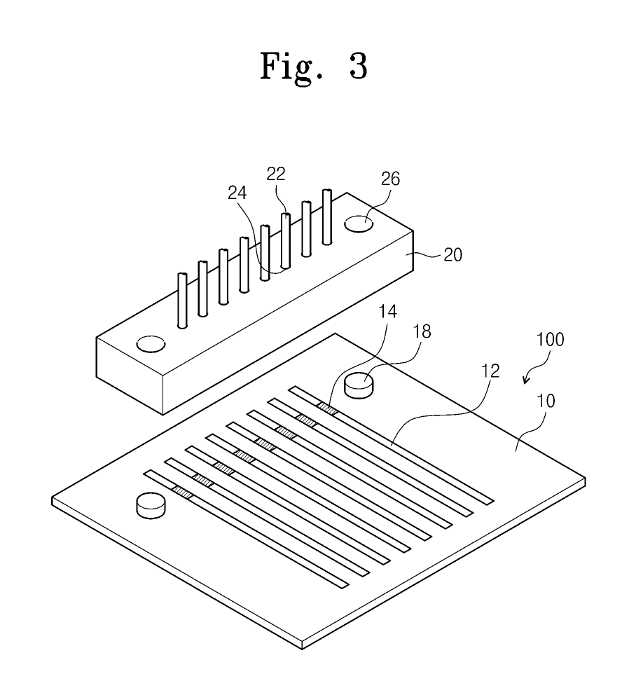

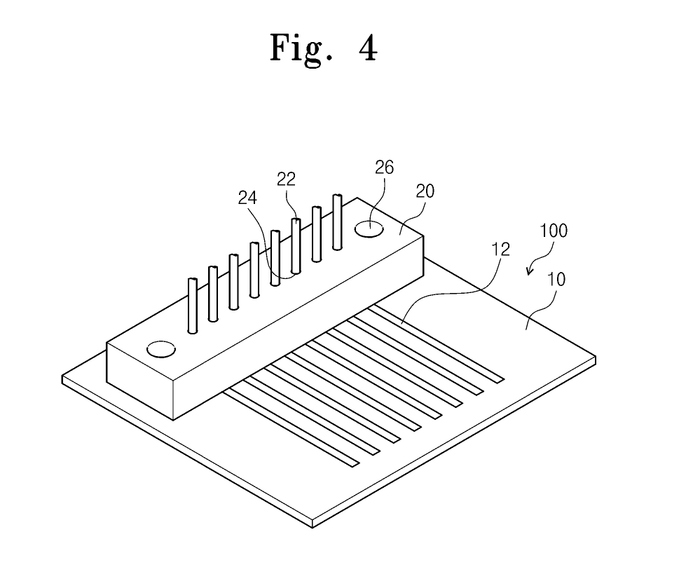

FIGS. 3 and 4 are exploded and assembled perspective views illustrating an optical apparatus comprising an optical connector according to a second embodiment of the present invention.

Referring to FIGS. 3 and 4, an optical connector 100 according to a second embodiment of the present invention may comprise a plurality of studs 18 that are inserted into second pin holes 26 of a ferrule 20 at both sides of optical waveguides 12 of a substrate 10. The plurality of studs 18 may align the substrate 10 and the ferrule 20. Also, the plurality of studs 18 may optically align optical fibers 22 aligned in the ferrule 20 and the optical waveguides 12 on the substrate 10.

Accordingly, since the optical connector 100 according to the second embodiment of the present invention allows the plurality of studs 18 disposed at both side of the optical waveguides 12 on the substrate 10 to be inserted into the second pin holes 26 of the ferrule 20, the optical alignment efficiency of the substrate and the ferrule 20 can be increased. Also, the optical coupling reliability of the optical fibers 22 aligned in the ferrule 20 and the optical waveguides 12 disposed in the substrate 10 can be increased.

The plurality of studs 18 may protrude from the substrate 10 by a certain height. For example, the plurality of studs 18 may be formed to have a height of about 50 μm to about 2,000 μm. The plurality of studs 18 may be collinear with at least one optical coupler 14. The plurality of studs 18 may have the same external diameter as the inner diameter of the second pin holes 26. The plurality of studs 18 may be formed by etching the substrate 10. Also, the plurality of studs 18 may comprise at least one of a thin film pattern and a solder ball. The thin film pattern may be patterned by a photolithography method in which a thin film is deposited on the substrate. The thin film pattern may comprise at least one of crystalline silicon, silicon oxide, metal, and glass. The solder ball may be formed on the substrate 10 through a printing method. The plurality of studs 18 may become a ferrule alignment unit that aligns the ferrule 20 on the substrate 10.

The plurality of second pin holes 26 formed in the ferrule 20 may have the same inner diameter as the external diameter of the plurality of studs 18. Adhesive may be coated on the plurality of second pin holes 26 and the plurality of studs 18 to fix the substrate 10 and the ferrule 20.

Accordingly, the optical connector 100 according to the second embodiment of the present invention may increase alignment efficiency with the ferrule 20 by using the plurality of studs 18 formed at the both sides of the optical waveguides 12 on the substrate 10.

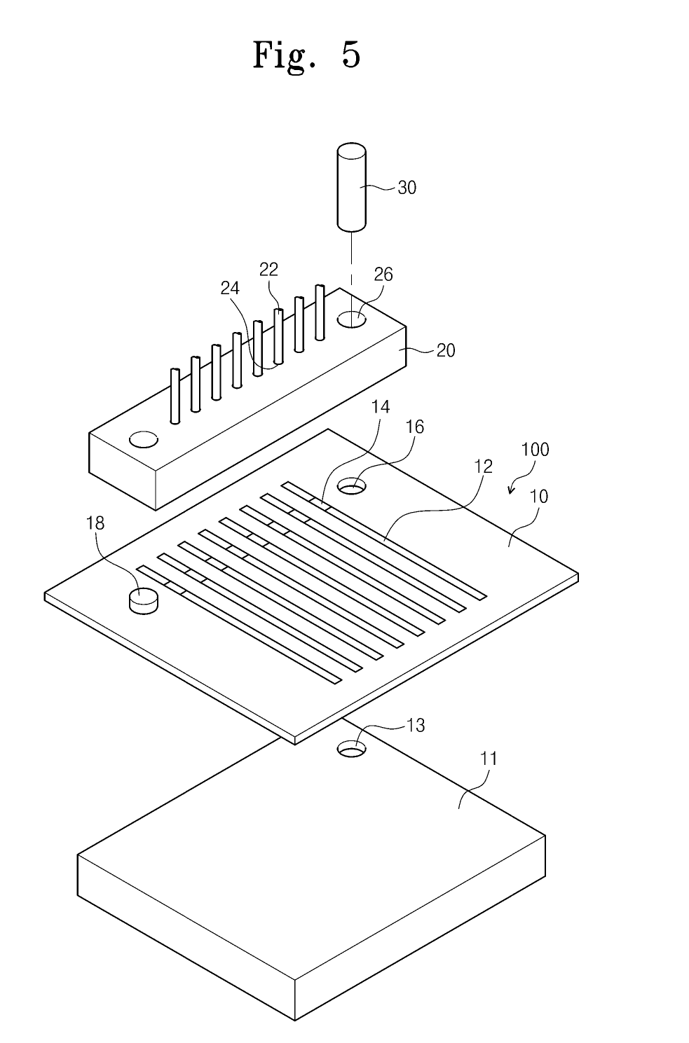

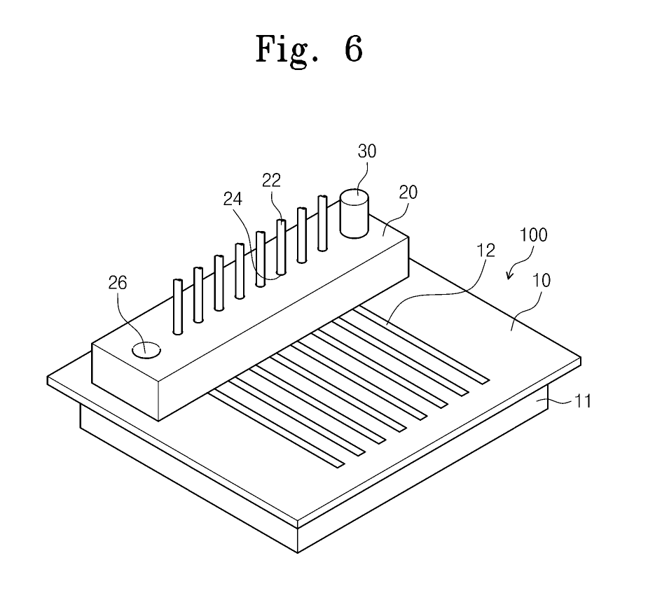

FIGS. 5 and 6 are exploded and assembled perspective views illustrating an optical apparatus comprising an optical connector according to a third embodiment of the present invention.

Referring to FIGS. 5 and 6, an optical connector 100 according to a third embodiment of the present invention may comprise a first pin hole 16 and a stud 18, which are disposed at both sides of optical waveguides 12 on a substrate 10, respectively. The first pin hole 16 may allow a guide pin 30 passing though a second pin hole 26 of a ferrule 20 to pass through. The stud 18 may be inserted into the second pin hole 26. The first pin hole 16 and the stud 18 may align the substrate 10 and the ferrule 20.

Accordingly, the optical connector 100 according to the third embodiment of the present invention can increase alignment efficiency of the ferrule 20 and the substrate 10 using the first pin hole 16 and the stud 18, which are formed at the both sides of the substrate 10 respectively. Also, the optical coupling reliability of optical fibers 22 and the optical waveguides 12 aligned in the ferrule 20 can be increased.

The first pin hole 16 may be disposed at one side of an optical coupler 14, and the stud 18 may be disposed at the other side of the optical coupler 14, opposite to the first pin hole 16. The first pin hole 16 and the stud 18 may become a ferrule alignment unit that aligns the ferrule 20 on the substrate 10. The first pin hole 16 and the stud 18 may be collinear with the optical coupler 14. The first pin hole 16 and the stud 18 may be formed to have a circular shape in the substrate. When the plurality of second pin holes 26 have the same size, the first pin hole 16 and the stud 18 may have the same diameter.

The first pin hole 16 and the second pin holes 26 may have the same diameter. The first pin hole 16 and the second pin holes 26 may receive the guide pin 30. The guide pin 30 may align and fix the substrate 10 and the ferrule 20. That is, the guide pin 30 may align the optical coupler 14 on the substrate 10 and the optical fibers 22 of the ferrule 20. The guide pin 30 may be formed to have a shaft or wedge shape having the same diameter as the first pin hole 16 and the second pin holes 26. When adhesive is coated on the first pin hole 16 and the second pin holes 26 into which the guide pin 30 is inserted, the substrate 10 and the ferrule 20 may be fixed. An auxiliary substrate 11 may also be disposed under the substrate 10 to prevent the substrate 10 from being damaged by the guide pin 30. Also, an auxiliary pin hole 13 may also be formed in the auxiliary substrate 11 to receive the guide pin 30.

The optical connector 100 according to the third embodiment of the present invention can increase or maximize alignment efficiency of the ferrule 20 and the substrate 10 where the plurality of second pin holes 26 are formed, by using the first pin hole 16 and the stud 18 that are formed at the both sides of the optical coupler 14, respectively. Also, the optical junction efficiency of the optical coupler 14 and the optical fibers 22 on the substrate 10 can be increased or maximized.

As described above, according to embodiments of the present invention, alignment efficiency of a substrate and a ferrule can be increased by using at least one pin holes and studs that are formed in substrate.

Also, optical coupling reliability of optical fibers aligned in a ferrule and an optical coupler on a substrate can be increased by using pin holes and studs.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical connector comprising:
a substrate;
at least one optical waveguide on the substrate;
an optical coupler on the optical waveguide; and
a ferrule alignment unit allowing a ferrule fixing optical fibers combined with the optical coupler to be aligned with the substrate.

2. The optical connector of claim 1, wherein the ferrule alignment unit comprises a plurality of pin holes in the substrate.

3. The optical connector of claim 2, wherein the plurality of pin holes are formed at both sides of the optical coupler in a direction of crossing the optical waveguide.

4. The optical connector of claim 3, wherein the plurality of pin holes are formed colinear with the optical coupler.

5. The optical connector of claim 2, further comprising guide pins inserted into the plurality of pin holes.

6. The optical connector of claim 5, further comprising an auxiliary substrate disposed under the substrate.

7. The optical connector of claim 6, wherein the auxiliary substrate has an auxiliary pin hole having the same size as the pin holes.

8. The optical connector of claim 1, wherein the female alignment unit comprises a plurality of studs.

9. The optical connector of claim 8, wherein the studs comprises at least one of a thin film pattern and a solder ball.

10. The optical connector of claim 1, wherein the ferrule alignment unit comprises a pin hole and a stud formed at both sides of the optical waveguide in a direction of crossing the optical waveguide, respectively.

11. The optical connector of claim 1, wherein the optical coupler comprises a grating coupler.

12. An optical apparatus comprising:
an optical fiber;
a ferrule fixing the optical fiber; and
an optical connector comprising an optical coupler combined with the optical fiber fixed in the ferrule, an optical waveguide connected to the optical coupler, a substrate comprising the optical waveguide and the optical coupler formed therein, and a ferrule alignment unit aligning the ferrule on the substrate.

13. The optical apparatus of claim 12, wherein the ferrule has a second pin hole corresponding to the ferrule alignment unit on the substrate.

14. The optical apparatus of claim 13, wherein the ferrule alignment unit comprises a stud inserted into the second pin hole.

15. The optical apparatus of claim 13, further comprising a guide pin inserted into the second pin hole.

16. The optical apparatus of claim 13, wherein the ferrule alignment unit has a first pin hole allowing the guide pin inserted into the second pin hole to pass through.

17. The optical apparatus of claim 12, wherein the ferrule allows the optical fiber to be coupled to the optical coupler at an inclined angle of about 70 degrees to about 80 degrees.
